(19) United States
(12) Patent Application Publication
(10) Pub. No.: US 2004/0226256 A1
(43) Pub. Date: Nov. 18, 2004

(54) CONTROL METHOD FOR MOVING RACKS

(75) Inventors: Kunio Miyazaki, Kumamoto-shi (JP); Tomoyuki Kawano, Kumamoto-shi (JP); Kazuya Tokunaga, Kumamoto-shi (JP); Ichiro Ikenaga, Kumamoto-shi (JP)

Correspondence Address: ERNEST A. BEUTLER, ATTORNEY AT LAW, 10 RUE MARSEILLE, NEWPORT BEACH, CA, 92660, US

(73) Assignee: KONGO KABUSHIKI KAISHA, Kumamoto-shi (JP)

(21) Appl. No.: 10/709,217

(22) Filed: Apr. 22, 2004

(30) Foreign Application Priority Data
May 12, 2003 (JP) 2003-284095

(51) Int. Cl. B42F 1/00

(52) U.S. Cl. 52/741.1

(57) ABSTRACT

Several embodiments of moveable partitioning systems wherein the relative positions of the partitions are controlled by non-contact sensors and various control systems therefore that permit controlled movement between the partitions to maintain either close spacing thereof of the establishment of predetermined width aisles between them. In addition the control system insures parallel movement of the partitions even if they are supported on a surface without tracks.

### BACKGROUND OF INVENTION

This invention relates to moveable partitions, such as storage racks that are moveable relative to each other by means of respective drive mechanisms and wherein the partitions may be controlled to automatically position the partitions in at least two different positions relative to each other.

It is well known to provide a variety of partitions that may be moved relative to each other for a variety of purposes. For example, it is common to utilize storage racks that may be moved to positions close to each other to free up space for other uses. The racks may them be moved relatively to each other to open an aisle between adjacent racks to access their storage areas to place or remove objects from them. Oftentimes a power source such as an electric motor is utilized to effect such movement.

It has been a practice in some instances to provide pre-settings to this powered movement to facilitate the movement and require less operator action. One way this has been done is to provide a control that if particular moving racks are specified a command is issued to establish a working passage between the selected racks. The control then controls the movements of the racks based on this determination. However this type of arrangement requires a limit switch or the like on each moving rack that comes in contact with an adjacent rack or a distance measuring element such as a wall or a stopper to detect the limit of the movement so that the control stops the drive of the moving rack in the desired position.

Thus it is required that, when a command to form a working passage is issued, the current positions of individual moving racks need be recognized and the racks to be moved and their moving directions must be determined from the relation between the current positions of the racks and the location of a working passage to be formed. This means that mutual signal transmission and reception between the racks are required, causing complex control, resulting in complex control systems. In addition the racks must be connected to each other by cables for signal communication, causing complicated wiring.

Therefore it is a principal object of this invention to provide a simplified but very effective control system and method for positioning moveable partitions.

In many instances the partitions are mounted on rails or tracks for their movement. However this means that the area they will traverse becomes complicated and expensive. Also the provision of these rails or tracks restricts other uses of the occupied area.

Therefore arrangements have been proposed where the partitions are mounted on wheels or endless transmitters that operate directly on a conventional floor and are driven to effect movement along that floor. However when the partition has substantial length several sets of these wheels or endless transmitters must be employed at spaced transverse locations. If straight line movement is required, as it often is, then some arrangement must be employed for synchronizing their movement. This obviously adds to the cost and complexity. In addition this also restricts all movement to straight line movement.

Therefore it is a further object of the invention to provide a control mechanism that can selectively control and establish straight line movement, but only when it is required.

### SUMMARY OF INVENTION

A first feature of the invention is embodied in a moveable partition arrangement comprised of a first partition having a drive mechanism for altering the position of the first partition. There is also a member. A distance sensing device is positioned on at least one of the first partition and the member for sensing the distance between the partition and the member. A control carried by the first partition operates the drive in response to an input signal to maintain a predetermined distance between the first partition and the member.

In accordance with another feature of the invention a moveable partition is provided that is mounted on at least a pair of driven ground engaging devices for moving the partition along a surface. A pair of position sensors are provided at transversely spaced positions on the partition and act with a fixed planar surface to provide control signals to the drives for the ground engaging elements to maintain parallel movement of the partition.

### BRIEF DESCRIPTION OF DRAWINGS

FIG. 1 is a schematic side elevational view of a conventional rack system having controlled rack positioning.

FIG. 2 is a schematic side elevational view, in part similar to FIG. 1 of a rack system having a controlled rack positioning method in accordance with an embodiment of the invention.

FIG. 3 is a schematic side elevational view, in part similar to FIGS. 1 and 2 of a rack system having a controlled rack positioning method in accordance with another embodiment of the invention.

FIG. 4 is a schematic view showing the position detecting arrangement in accordance with the invention.

FIG. 5 is a block diagram of a method of operation in accordance with the invention.

FIG. 6 is a top plan view of a rack system having a controlled rack positioning method in accordance with still another embodiment of the invention.

FIG. 7 is a top plan view, in part similar to FIG. 6 of a rack system having a controlled rack positioning method in accordance with yet another embodiment of the invention.

FIG. 8 a block diagram of another method of operation in accordance with the invention.

FIG. 9 is a top plan view, in part similar to FIGS. 6 and 7 of a rack system having a controlled rack positioning method in accordance with still further embodiment of the invention

### DETAILED DESCRIPTION

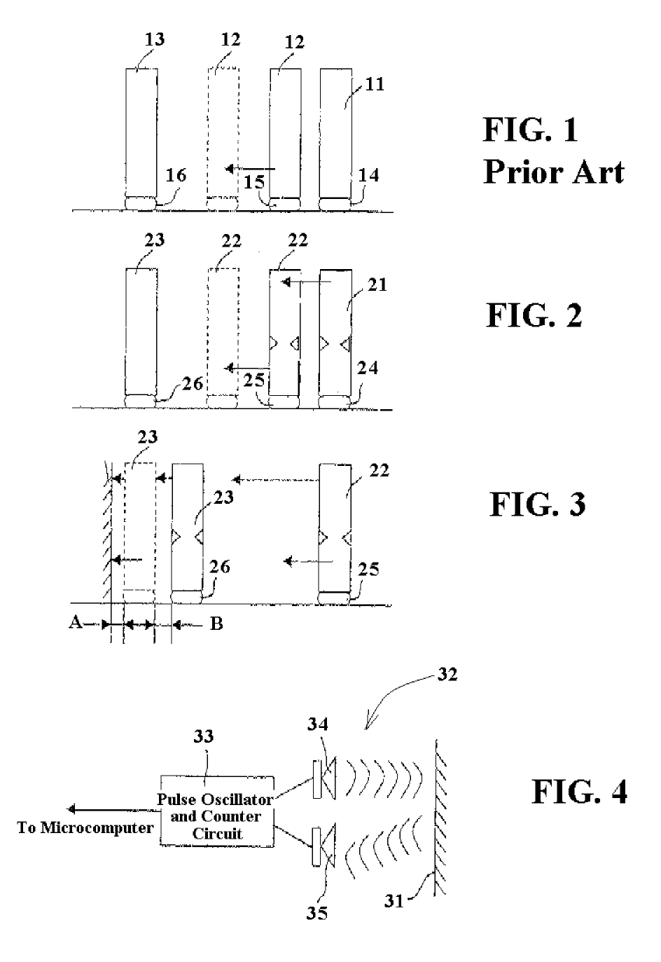

Referring now in detail to the drawings and initially to FIG. 1, it shows, as noted, a side elevational view of a prior art type of rack system having positioning control. As illustrated the system includes three moveable racks 11, 12, 13 supported for movement upon. They may be supported by running wheels at the bottom with the running wheels mounted on guide rails so that the moving rack are movable along the guide rails. These wheels are driven in a suitable manner, for example by electric motors. However, in the example shown in FIG. 1, the bottoms of the moving racks 11, 12 and 13 incorporate running devices 14, 15 and 16, respectively of an endless track type. These endless track type running devices 14, 15 and 16, are driven by, for example by electric motors (not shown) for moving racks 11, 12 and 13 directly on the floor in a straight line without guide rails.

The racks 11, 12 and 13 can be positioned normally in close side by side relation to provide space that can be used for other purposes. As shown in solid line view, however, the racks 11 and 12 are closely spaced and the rack 12 is spaced from the rack 13 to allow an aisle so that articles may be placed on or removed from either of these racks 12 and 13. If however it is desired to provide access to the rack 11 as well as the rack 12, an open command switch, for example, is operated to move the rack 12 toward the left as shown in the phantom line position shown in this figure. This movement continues until the rack 12 is moved and comes in contact with the rack 13 or an appropriate proximity switch or the like. Upon this detection, the movement of the moving rack 12 is stopped. This mechanism and method of operation has the defects already noted.

Referring now to FIG. 2, this shows, for example three racks 21, 22 and 23 supported on driven guide tracks 24, 25 and 25, respectively, that are also driven by suitable power sources such as electric motors (not shown). It should be noted here that in the examples described a minimum number of racks necessary to describe the invention are shown, but those skilled in the art will readily understand from the description that the invention may be practiced with any desired number of racks or other moveable partitions. The movement that is made is generally like the prior art, however the control apparatus and method is quite different.

The racks 21, 22 and 23 are initially placed in the same location as in FIG. 1 where an aisle is provided between the racks 22 and 23 and the racks 21 and 22 are in close proximity. When the command signal is given, the rack 22 is driven to the left to establish the preset distance between the racks 21 and 22 and then stopped. This movement is shown by the phantom line position of rack 22.

However a condition may arise that the rack 23 will interfere with this movement of the rack 22. The controls for each of the racks 21, 22 and 23 are such that a predetermined minimum distance can not be exceeded. If this happens because the rack 23 was initially too close to the rack 22 to permit the desired aisle width between the racks 21 and 22 to be established, the rack 23 will be thereafter driven to the left by its drive 26 to maintain the set minimum distance between the racks 23 and 22 so the desired aisle width between the racks 22 and 21 may be established.

In addition to sensing proximity between adjacent racks as the racks 21, 22 and 23, the position sensors may also sense the condition relative to stationary objects such as a fixed wall 27, as shown in FIG. 3. As has been noted, if the rack 22 is being moved to the left to provide the desired aisle between it and the rack 21 (not shown in FIG. 3) the rack 23 will be moved to the left to maintain the desired spacing between it and the rack 22.

However if this movement brings the rack 23 close to the wall 27 at a distance “A” which is the distance the rack 23 will travel by inertia after a stop command is issued to stop the movement of the rack 23 as shown by the phantom line view of this rack. The rack 22, however, will be permitted to continue to travel to establish the desired aisle between it and the rack 21(not shown in FIG. 3). However this continued movement of the rack 22 is only permitted until a stopping distance “B” is reached between it and the stopped rack 23. This is to establish a small, minimum air gap between the racks for air circulation purposes.

The proximity sensors utilized to achieve these actions are shown schematically in FIG. 4, which will now be referred to. A member being sensed is indicated at 31 and from the foregoing description it will be understood that this may be a rack or a fixed object such as a wall. The distance sensor indicated generally at 32 is a non-contact type distance sensor utilizing ultrasonic waves.

The distance sensor 32 is comprised of a pulse oscillator and counter circuit 33. The pulse oscillator 33 is a device for generating an ultrasonic signal, and the generated ultrasonic wave is emitted from a sounding body 34 corresponding to a speaker toward the member 31 which comprises a reflector. The sounding body 34 has a high directivity.

Also, a sound sensing body 35 corresponding to a microphone is connected to the counter circuit of the pulse oscillator and counter circuit 33. The sound sensing body 35 also has a high directivity. The sound sensing body 35 is arranged to receive an ultrasonic wave reflected by the reflector 31 and to convert it into an electric signal to be inputted to the counter circuit. The sounding body 34 and sound sensing body 35 are disposed on the same plane. In the pulse oscillator and counter circuit 33, the time is counted from the moment that an ultrasonic wave is emitted from the sounding body 34 to the moment that its reflected wave is received by the sound sensing body 35.

The counted value is inputted for processing in a microcomputer, a microprocessor, or the like including the control means, providing measurement of the distance between the sounding body 34 and sound sensing body 35 and the reflector 31. Such a distance sensor utilizing ultrasonic waves is itself known and the detailed description is not believed necessary to permit those skilled in the art to practice the invention.

The foregoing distance sensor utilizing ultrasonic waves is provided on each rack. The sounding body 34 and sound sensing body 35 of the distance sensor are disposed facing the opposing face of an adjacent rack, with the front faces of the sounding body 34 and sound sensing body 35 coinciding with the front face of the rack. On the opposing face of the adjacent moving rack to the sounding body 34 and sound sensing body 35 is provided the reflector 31. The surface of the moving rack itself may be the reflector 31. Also such a reflector is positioned on any facing wall, the surface of which itself may be the reflector 31.

At lease one distance sensor should be provided on each of the opposing faces of the rack to the adjacent rack or the fixed object or wall measuring face. Thus two distance sensors are associated with each rack. Alternatively, as in the embodiment described later, in the case of guide rail type racks, one distance sensor should be provided on at least one of opposing racks. However, if a plurality of distance sensors are provided on the left and right sides of an opposing face of a rack to the adjacent rack or fixed object or distance measuring face as viewed from the moving direction of the rack, i.e., on the left and right longitudinal sides of the moving rack, they are effective for preventing of movement of the rack. In particular, they are effective in rail-less type racks. More specifically, when a plurality of distance sensors are provided on the left and right sides of a rack and a plurality of independently drive wheels are also provided on the left and right sides of the rack control of the left and right drive wheels of the rack independently in response to the outputs of the corresponding distance sensors. Therefore, when one side of a rack is moving more than the other to cause oblique movement of the rack, this can be detected and the control of the drive speed of the drive wheel on the side excessively moving ahead can be corrected to maintain parallel movement of the rack.

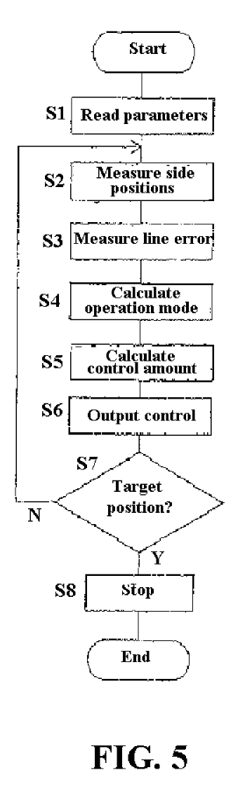

The control routine for the positioning will now be described by reference to FIG. 5. When the operation is started, first, various parameters are read from a memory at the step S1. One of the parameters is an associated movement distance, this being a preset distance that is kept between moving racks when a plurality of racks are moving in parallel movements. A second parameter is a braking distance. The braking distance is a distance at which brake application is started to reduce the moving speed of a moving rack when the moving rack approaches an adjacent moving rack or a distance measuring face such as an end stopper and a wall and nearly reaches its moving limit. Another parameter is a stopping distance. The stopping distance is a distance at which a moving rack reaches its moving limit and the movement of the moving rack is stopped. These parameters are set in advance, which are read and stored in a memory.

Then at the step S2 the left and right distances of the moving rack are measured. These left and right distances are distances between end areas of a moving rack and an opposing rack or fixed object. This is done to determine if the moving rack is moving obliquely as mentioned previously. This is desirable for a moving rack in which drive wheels or tracks are provided independently on the rack ends and in which each drive is independently speed controlled for the correction of such oblique movement.

Then, operation line error measurement is performed at the step S3. The operation line error measurement is not required when the moving rack is a type which moves along guide rails. However it is necessary for a moving rack which has an endless track type running device and with which guide rails are not required. If the rack has moved obliquely before correction it mal be displaced transversely from the desired parallel path of movement. This is done by comparison with a scanning operation line marked on the floor surface on which an moving rack is installed or on a wall or ceiling above the moving rack to determine a tracing error of the moving rack with respect to the operation line.

If it is determined that the moving rack is moving obliquely in the measurement or the left and right distances at the step S2 and/or that the moving rack is displaced in the lateral direction with respect to the operation line as a result of the operation line error measurement at the step S3, at the Step S4 an operation mode calculation is performed to calculate which one of the independently driven left and right drive wheels is to be driven faster than the other to make the necessary correction.

In addition at the step S5 a further, calculation of the amount of control is performed based on the foregoing calculation result, and at which a specific drive speed is calculated. Also at the step S5 the calculation of the amount of control required is compared with the initially read various parameters from the step S1 to calculate the desired moving speeds of the individual racks are calculated and determine if the moving racks have reached their respective positions where they are to be braked.

Based on the determinations made at the step S5, a speed control signal is outputted at the step S6. That is the drive motors are controlled individually according to the control signal to thereby correct oblique movement of the moving rack or its displacement with respect to the operation line, and further, if a given position for the moving rack to be braked is reached, the individual drive motors are controlled for deceleration to be braked.

Then at the step S7 if a given target position is reached, the drive motors are stopped at the step S8 and the operation is finished. If not the program moves back to the step S2 and repeats the operation again.

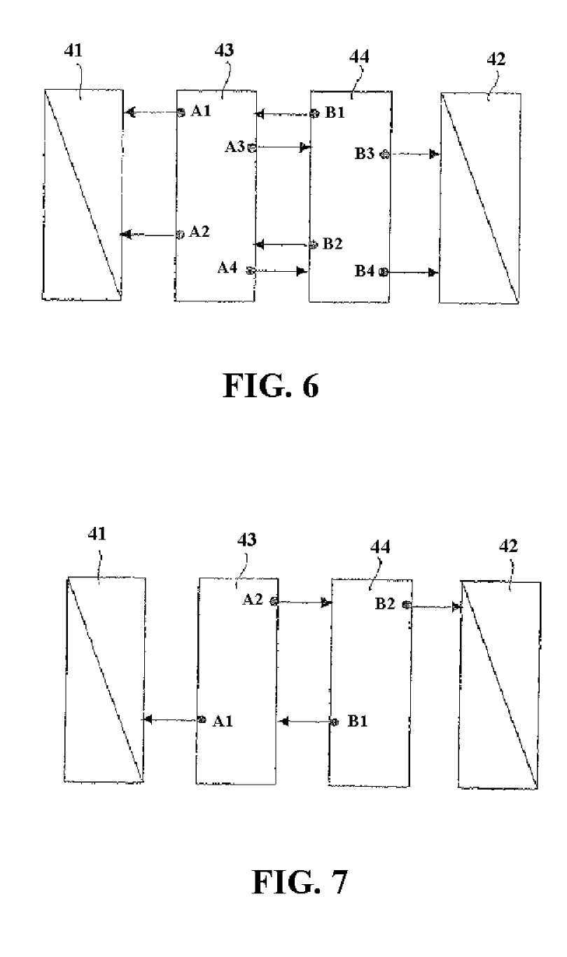

The previously described embodiment may be characterized as independent recognition type racks in which the relative position of a rack to an adjacent rack is independently detected in each moving rack. FIG. 6 shows an independent recognition type having fixed end racks 41 and 42. Between these fixed end racks 41 and 42 are disposed moveable racks 43 and 44. These racks 41, 42, 43 and 44 are disposed such that their facing sides are open to permit for storage articles to be put in and out. The moving racks 43, 44 are supported for movement toward the respective fixed rack 41 and 42 for compaction and space utilization or away from them to form, between them, first, second, and third aisles to permit articles to be put in and removed. It is also possible to place a greater number of moveable racks between the fixed racks 41, 42that are likewise movable between a compact condition and one in which aisles are formed between them.

The moving rack 43 has proximity sensors A1, A2, each made up of an ultrasonic sensor,as previously described, disposed on opposite sides of the face opposing the fixed rack 41 to measure the distance between the moving rack 43 and the fixed rack 41, that is, the width of the aisle between them. The moving rack 43 also has proximity sensors A3 and A4, each made up of an ultrasonic sensor, as previously described, on the left and right sides of the opposing face to the moving rack 44, and is adapted to measure the distance between the moving rack 43 and the moving rack 44, that is, the width of the second passage independently on the left and right sides. The moving rack 44 has distance sensors B1, B2 each made up of an ultrasonic sensor,as previously described, mounted on ends of the face opposing the moving rack 43, to measure the distance between the moving rack 43 and the moving rack 44, that is, the width of the aisle at its ends.

The moving rack 44 also has distance sensors B3, B4 each made up of an ultrasonic sensor,as previously described, on the face opposing the fixed rack 42at its ends to measure the distance between the moving rack 44 and the fixed rack 42, that is, the width of a third aisle. The moving racks 43 and 44 have motors as drive sources for independently driving for drive wheels or tracks positioned at the ends of the moving racks and have control means for independently controlling the rotation of these motors. The control means may be constituted of for example, a microprocessor or a logic IC.

The operation of this embodiment is as follows. If the moving rack 43 moves toward the left in FIG. 6, the distance between the moving rack 43 and the fixed rack 41 is detected by the distance sensors A1, A2, and if there is a difference in the detected value between the distance sensors A1, A2, that is, in the case of oblique movement, control means constituted of a microprocessor or the like controls the left and right motors independently to eliminate the difference in the detected value. If the distance sensors A1, A2 detect the fact that the distance between the moving rack 43 and the fixed rack 41 has reached a predetermined stopping distance, the control means of the moving rack 43 stops the drive of the left and right motors to stop the movement of the moving rack 43.

If, on the other hand the moving rack 43 moves toward the right in FIG. 6, the distance between the moving rack 43 and the moving rack 44 is measured by the distance sensors A3 and A4 of the moving rack 44. If there is a difference in the detected value between the distance sensors A3, A4, the control means constituted of a microprocessor or the like controls the left and right motors independently to correct the oblique movement.

On the other hand, regarding the moving rack 44, the distance between the moving rack 44 and the moving rack 43, that is, the width of the aisle between them is measured by the left and right distance sensors B1 and B2. If it is detected that the moving rack 43 has approached up to a predetermined distance, then the distance between the moving rack 44 and the fixed rack 42, that is the aisle between them is measured by the distance sensors B3 and B4. If as a result of the measurement of the width of aisle, if it is found that there is a distance enough for the moving rack 44 to move, the control means of the moving rack 44 controls for rotation the drive motors of the moving rack 44 to move the moving rack 44 to the right in FIG. 6 toward the fixed rack 42. It is designed such that the moving speed of the moving rack 44 at this time is approximately the same as the moving speed of the moving rack 43.

However if the distance between the moving rack 44 and the fixed rack 42 measured by the distance sensors B3 and B4 of the moving rack 44 has reached a predetermined stopping distance, the control means of the moving rack 44 stops the motors of the moving rack 44. Thereafter if the distance between the moving rack 43 and the moving rack 44 measured by the distance sensors A3 and A4 of the moving rack 43 has reached a predetermined stopping distance, the control means of the moving rack 43 stops the motors of the moving rack 43 to stop the moving rack 43. As a result, the moving racks 43 and 44 and fixed rack 42 will be stopped in a converged state.

According to the foregoing embodiment, since the moving racks 43, 44 recognize their own positions by themselves and control the rotation of their motors based on the recognition results, mutual signal transmission between racks is not needed. Thus information transmission means such as wires for connecting racks or radio communication therebetween are dispensed with or can be simplified. Also since the width can be measured independently on the ends of the moving rack for the detection of oblique movement, and since the left and right drive motors can be controlled independently based on the detection results for the correction of oblique movement, this invention can be applied to the foregoing rail-less type moving racks.

In the embodiment just described, the invention was utilized with a rail-less type or rack system, it can also be used effectively with moving racks which move while guided by guide rails. If this invention is applied to moving racks with guide rails, the number of distance sensors can be reduced significantly as shown in the embodiment of FIG. 7. As seen in FIG. 7, two moving racks 43 and 44 are disposed for movement between two fixed racks 41 and 42. Although not illustrated in the drawing, guide rails are provided between fixed racks 41 and 42, along which the moving racks 43 and 44 move. The guide rails may be laid on the floor, on which the moving racks move, or the guide rails may be fixed above the moving racks, from which the moving racks 43 and 44 are suspended for movement. The moving racks 43 and 44 may each have one motor as their drive source, and may be arranged such that end drive wheels of the moving racks are integrally driven for rotation by the one motor. That is, plurality of motors need not be provided for driving for rotation the drive wheels of a given rack independently.

The moving rack 43 has a distance sensor Al as previously described on the face opposing the fixed rack 41 and which is adapted to measure the distance between the moving rack 43 and the fixed rack 41, that is, the width of the aisle therebetween. The moving rack 43 also has a distance sensor A2 as previously described on the opposing face to measure the distance between the moving rack 43 and the moving rack 44, that is, the width of the aisle between them.

The moving rack 44 has a distance sensor B1 as previously described on the opposing face to the moving rack 43, and is adapted to measure the distance between the moving rack 44 and the moving rack 43, that is, the width of the aisle between them. The moving rack 44 also has a distance sensor B2 made up of an ultrasonic sensor on the opposing face to the fixed rack 42, and is adapted to measure the distance between the moving rack 44 and the fixed rack 42, that is, the width of the aisle between them. In this way, each moving rack has one distance sensor on each of the opposing faces to an adjacent moving rack or a fixed rack, and thus has half the number of distance sensors compared with the embodiment shown in FIG. 6 The distance sensors of the moving racks may be disposed one-sided on the right or left end of the moving rack or may be disposed centrally. Also, the moving racks 43 and 44 have a motor as their drive source for driving for rotation drive wheels on the ends of the moving racks and have control means for independently controlling the rotation of these motors.

The operation of the embodiment shown in FIG. 7 is approximately the same as that of the embodiment shown in FIG. 6 as described below, except that the oblique movement correction operation such as performed in the embodiment shown in FIG. 6 is not included. That is that if the moving rack 43 moves toward the left in FIG. 7, the distance between the moving rack 43 and the fixed rack 41 is detected by the distance sensor A1 provided on the opposing face to the fixed rack 41. If the distance sensor A1 detects the fact that the distance between the moving rack 43 and the fixed rack 41 has reached a predetermined stopping distance, the control means of the moving rack 43 stops the drive of the motor to stop the movement of the moving rack 43.

Next, if the moving rack 43 moves toward the right in FIG. 7, the distance between the moving rack 43 and the moving rack 44 is measured by the distance sensor A2 provided on the opposing face to the moving rack 44. In addition, regarding the moving rack 44, the distance between the moving rack 44 and the moving rack 43, that is, the width of the aisle between them is measured by the distance sensor B1. If it is detected that the moving rack 43 has approached up to a predetermined distance, the distance between the moving rack 44 and the fixed rack 42, that is, the width of the aisle between them is measured by the distance sensor B2 on the side of the face opposing the fixed rack 42. As a result of measurement of the width of the aisle between them, if it is found that there is a distance enough for the moving rack 44 to move, the control means of the moving rack 44 controls for rotation the motor of the moving rack 44 to move the moving rack 44 to the right toward the fixed rack 42.

If the distance between the moving rack 44 and the fixed rack 42 measured by the distance sensor B2 of the moving rack 44 has reached a predetermined stopping distance, the control means of the moving rack 44 stops the motor of the moving rack 44 to stop the moving rack 44. Thereafter, if the distance between the moving rack 43 and the moving rack 44 measured by the distance sensor A2 of the moving rack 43 has reached a predetermined stopping distance, the control means of the moving rack 43 stops the motor of the moving rack 43 to stop the moving rack 43. As a result, the moving racks 43 and 44 and fixed rack 42 will be stopped in a converged state.

In the case of a moving rack of a type having guide rails, as in the embodiment shown in FIG. 7 and described above, since oblique movement of the moving rack is prevented by the guide rails mechanically and prevents oblique movement from exceeding a certain degree, detection of oblique movement and correction control of oblique movement are not needed. Therefore, in the embodiment shown in FIG. 7, one distance sensor is disposed on each of the opposing faces of the moving racks to the working passages for the reduction of the number of distance sensors. The control flow or the control program for moving racks may also be simplified.

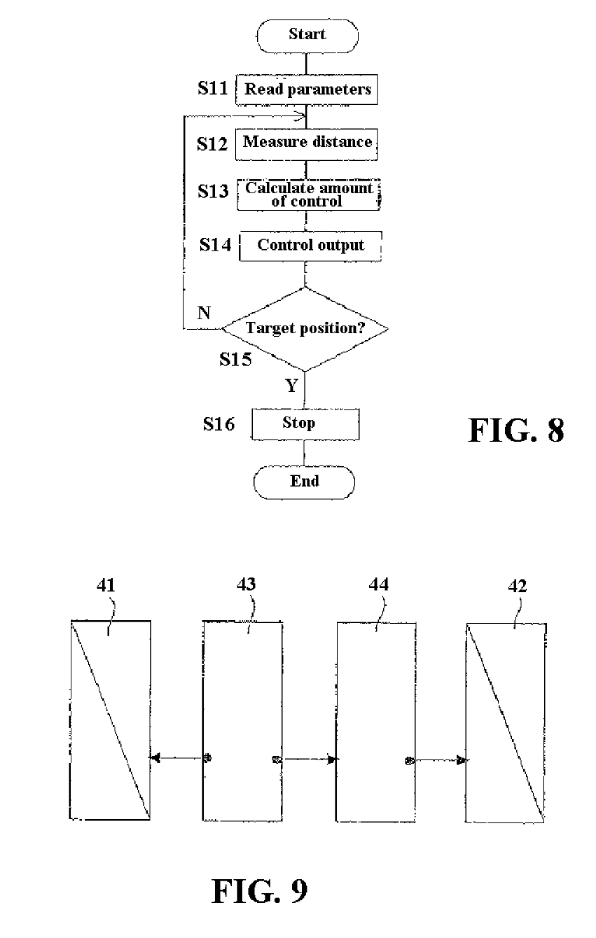

FIG. 8 shows an example of the control flow routine that is generally similar to that of FIG. 5, but simpler due to the provision of the tracks that prevent oblique movement or skewing. This routine is made up of a parameter reading step S11, the same as step S1 of the previously discussed routine, a distance measurement step S12, a step S13 of calculation of the amount of control, similar to the step S5 of FIG. 5, a control output step S14, similar to the step S6 of FIG. 5, a target position judgment step S15, similar to the step S7 of FIG. 5, and a stopping step S16 similar to the step S8 of FIG. 5.

This control flow is different from aforementioned FIG. 5 in that the operation line error measurement step of previous step S3 and the operation mode calculation step of step S4 are not required and in the distance measurement step S12 a simple distance measurement is performed rather than the measurement of the side distances. The reason for such differences in the operation flow is that a guide rail type moving rack can be regarded as being free from oblique movement and errors of the operation line.

The operation of the embodiment shown in FIG. 7 will now be described by reference also to FIG. 8. If the moving rack 43 moves toward the fixed rack 41, while it moves, the distance sensor Al measures the width of the aisle between the moving rack 43 and the fixed rack 41. If the distance between the moving rack 43 and the fixed rack 41 has reached a predetermined stopping distance, the control means of the moving rack 43 stops the drive motors to stop the movement of the moving rack 43.

However, if the moving rack 43 is moved toward the right in FIG. 7 and away from the fixed rack 41 the distance sensor A2 measures the width of the aisle between the moving rack 43 and the moving rack 44. Simultaneously with this moving operation, the moving rack 43 transmits data on the distance between the moving rack 43 and the moving rack 44, and the moving rack 44 also recognizes the distance between the moving rack 43 and the moving rack 44 because of the sensor B1. The width of the aisle between the moving rack 44 and the fixed rack 42, that is, the width of a third passage is measured by the distance sensor B2.

If the moving rack 43 has approached the moving rack 44 up to a predetermined distance and if, at this time, the aisle between the racks 44 and 42 has a width enough for the moving rack 44 to move, a control circuit of the moving rack 44 controls for rotation the motors of the moving rack 44 to move the moving rack 44 in the same direction as the movement of the moving rack 43 at approximately the same speed as the moving speed of the moving rack 43.

However, if the distance sensor B2 detects the fact that the moving rack 44 has approached the fixed rack 42 up to a predetermined stopping distance, the control means of the moving rack 44 stops the motors to stop the moving rack 44. Likewise, if the distance sensor A2 detects the fact that the moving rack 43 has approached the moving rack 44 up to a predetermined stopping distance, the control means of the moving rack 43 stops the motors to stop the moving rack 43.

Now still another embodiment, shown in FIG. 9, will be described. This embodiment is exemplified by a system in which distance information is transmitted between adjacent moving racks. The arrangement of rack is the same as the embodiments of FIG. 6 and FIG. 7, which is composed of two fixed racks 41 and 42 and two moving racks 43 and 44. In the embodiment of FIG. 9, the moving rack 43 has a distance sensor A1 as previously described on the face opposed to the fixed rack 41. This sensor A1 is which is adapted to measure the distance between the moving rack 43 and the fixed rack 41, that is, the width of the aisle between them.

The moving rack 43 also has a distance sensor A2 as previously described on the face opposed to the moveable rack 44, which is adapted to measure the distance between the moving rack 43 and the moving rack 44, that is, the width of the aisle between them. The moving rack 44 has a distance sensor B1, as previously described, on the face opposing the fixed rack 42. The sensor B1 is adapted to measure the distance between the moving rack 44 and the fixed rack 42, that is, the width of the aisle between them.

Considering the moving rack 43to be a main rack and the other moving rack 44 to be a dispersion rack, the main rack 43 is provided with two distance sensors (A1 and A2) and the dispersion rack is provided with only one distance sensor (B1). The detected output by the distance sensor A2 of the moving rack 43, that is, measured data on the width of the aisle between the racks 43 and 44 is also transmitted to the moving rack 44. Although only one dispersion rack is shown in FIG. 9, the number of the dispersion racks can be infinite in principle and, in any case, it is sufficient if there is provided one distance sensor for each dispersion rack. Therefore, the number of distance sensors can be reduced significantly. Also, as in the example of the moving racks 43 and 44, communication of measured data on the width of a passage by a distance sensor is performed between adjacent moving racks. The moving racks 43 and 44 have motors as drive sources for independently driving for rotation the left and right drive wheels, and have control means for independently controlling the rotation of these motors.

The embodiments shown in FIGS. 7 and 9 have an arrangement suitable for moving racks of a type which moves along guide rails. According to these embodiments, the number of distance sensors can be advantageously reduced. However, transmission of measured data by distance sensors is required between adjacent moving racks. This communication means may be a simple one because it is data transmission means. This communication means may be cables or wireless communication by such as electric waves or light beams.

Although the distance sensor for use in this invention may be a contact type distance sensor, a non-contact type is more useful because, in the case of the contact type distance sensor, mechanical connection is required between the moving rack and the fixed part, which is troublesome. The non-contact type distance sensor is not limited to the ultrasonic type shown in FIG. 4, but, for example, a triangulation type utilizing light beams, a magnetic detection type, or other various distance measurement type can be used.

Of course those skilled in the art will readily understand that the described embodiments are only exemplary of forms that the invention may take and that various changes and modifications may be made without departing from the spirit and scope of the invention, as defined by the appended claims.

1. A moveable partition arrangement comprised of a first partition having a drive mechanism for altering the position of said first partition, a member, a distance sensing device on at least one of said first partition and said member for sensing the distance between said partition and said member, and a control carried by said first partition for operating said drive in response to an input signal to maintain a predetermined distance between said first partition and said member.

2. A moveable partition arrangement as set forth in claim 1 wherein the distance sensing device comprises a non-contact sensor.

3. A moveable partition arrangement as set forth in claim 2 wherein the non-contact sensor has a transmitter for transmitting reflective signals to the component that does not carry it and a receiver for receiving signals reflected from the component that does not carry it.

4. A moveable partition arrangement as set forth in claim 1 wherein the member comprises a second partition having a second drive mechanism for altering its position a second control for operating said second drive mechanism.

5. A moveable partition arrangement as set forth in claim 4 further including a third partition positioned on the side of said first partition opposite to said second partition and a third drive mechanism for altering its position, a third control for operating said third drive mechanism.

6. A moveable partition arrangement as set forth in claim 5 wherein the control operates the third drive to maintain no less than a predetermined distance between said third partition and the first partition.

7. A moveable partition arrangement as set forth in claim 6 further including a fixed partition on the side of said third partition opposite the first partition and the third control maintains no less than a predetermined distance between said third partition and the fixed partition.

8. A moveable partition arrangement as set forth in claim 7 wherein the third control moves the third partition toward the fixed partition when the first control is moving the first partition away from the second partition and toward the fixed partition.

9. A moveable partition arrangement as set forth in claim 8 wherein the third control stops the movement of said third partition toward the fixed partition when the pre-determined position of the third partition is reached even if the first partition continues to move toward the third partition.

10. A moveable partition arrangement as set forth in claim 9 wherein the first control stops the movement of the first partition when it reaches a predetermined minimum distance from the third partition even if the input signal calls for further movement.

11. A moveable partition arrangement as set forth in claim 1 wherein the drive mechanism comprises a pair of transversely spaced, separately driven ground engaging members and the distance sensing device comprises a pair of position sensors provided at transversely spaced positions on the first partition acting with a fixed planar surface to provide respective distance signals indicative of the distances between said sensors and the planar surface, and the control controlling the speed of said driven ground engaging devices to maintain parallel movement of said partition.

12. A moveable partition arrangement as set forth in claim 11 wherein the position sensors comprise non-contact sensors.

13. A moveable partition arrangement as set forth in claim 12 wherein the non-contact sensors each have a transmitter for transmitting reflective signals to the fixed planar surface and a receiver for receiving signals reflected from the fixed planar surface.

14. A moveable partition arrangement as set forth in claim 13 wherein the member comprises a second partition having a second drive mechanism for altering its position, a second control for operating said second drive mechanism.

15. A moveable partition arrangement as set forth in claim 14 further including a third partition positioned on the side of said first partition opposite to said second partition and a third drive mechanism for altering its position, a third control for operating said third drive mechanism.

16. A moveable partition arrangement as set forth in claim 15 wherein the control operates the third drive to maintain no less than a predetermined distance between said third partition and the first partition.

17. A moveable partition arrangement as set forth in claim 16 further including a fixed partition on the side of said third partition opposite the first partition and the third control maintains no less than a predetermined distance between said third partition and the fixed partition.

18. A moveable partition arrangement as set forth in claim 17 wherein the third control moves the third partition toward the fixed partition when the first control is moving the first partition away from the second partition and toward the fixed partition.

19. A moveable partition arrangement as set forth in claim 18 wherein the third control stops the movement of said third partition toward the fixed partition when the predetermined position of the third partition is reached even if the first partition continues to move toward the third partition.

20. A moveable partition arrangement as set forth in claim 19 wherein the first control stops the movement of the first partition when it reaches a predetermined minimum distance from the third partition even if the input signal calls for further movement.

21. A moveable partition comprised of a partition member, at least a pair of driven ground engaging devices for moving said partition along a surface, a pair of position sensors provided at transversely spaced positions on said partition acting with a fixed planar surface to provide respective distance signals indicative of the distances between said sensors and the planar surface, and a control for controlling the speed of said driven ground engaging devices to maintain parallel movement of said partition.
